(19) United States
(12) Patent Application Publication
(10) Pub. No.: US 2003/0079134 A1
(43) Pub. Date: Apr. 24, 2003

(54) Method of secure print-by-reference

(75) Inventors: Daniel W. Manchala, Torrance, CA (US); Swen R. Johnson JR., San Gabriel, CA (US); John C. Wenn II, Redondo Beach, CA (US); Leonid Orlov, Hermosa Beach, CA (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/001,449

(22) Filed: Oct. 23, 2001

(51) Int. Cl. H04L 9/00

(52) U.S. Cl. 713/182; 705/76

(57) ABSTRACT

In a client-server-document repository system, a secure method of print-by-reference includes sending, from the client to the printer, user credentials to release a document, a delegation credential for permitting the printer to print the document and the address of the document; verifying, at the printer, the user's credentials and the delegation credential; sending, from the printer to the document repository, printer credentials, the delegation credential and the address of the document; verifying, at the document repository, the printer's credentials and the delegation credential; providing the document to the server; and printing the document. The client may be a wireless device such as a cell phone or personal digital assistant.

### BACKGROUND OF THE INVENTION

This invention relates generally to methods of manipulating documents by reference, and in particular, to a secure method of print-by-reference.

Print-by-reference is a commonly used term to refer to the process of printing a document that is not stored locally with the client or user. In print-by-reference, the user or client sends the address of the document to the printer, the printer fetches the document stored at that address (usually in a document repository) and prints the document. The three entities—client, server (in this case, the printer) and the document repository can be physically located long distances apart and may be connected via an intranet or the Internet.

Wireless devices such as cell phones and personal digital assistants (PDAs) have limited storage and typically cannot be used to store large documents such as Microsoft Word documents, Postscript files, Adobe PDF files, and so on. To solve this problem, many wireless devices carry a reference (e.g., a uniform resource locator—URL) for documents not stored on the wireless device. When the documents are needed to be printed, the URL is sent to the printer, and the printer is asked to fetch the document stored at the URL.

The IPP (Internet Printing Protocol) uses https between a print client and a print server to achieve client and server authentication. In addition, IPP makes use of BAA (Basic Access Authentication) over SSL (Secure Socket Layer—a https connection) to provide user authentication. Several devices have been built conforming to IPP standards. IPP also addresses print-by-reference, but does not discuss how it can be done securely. Secure printing is achieved by the client obtaining the document from a web server and sending the document securely to a printer (which is not print-by-reference).

The Xerox Satchel System provides mobile users with access to remote documents and documentation services using a mobile browser. Satchel browsers do not deal with documents directly, but with secure document references called tokens. A Satchel token may be passed directly to another browser in order to convey permissions to a specific document. Tokens may also be passed to document services to grant them permission to, say, fetch the document for printing. Each token incorporates a digital signature. Tokens are signed using public key cryptography and grant access to just one document. Signatures are carried in tokens as HTTP headers, which are ignored by public Web servers and proxies. Requests made to the Satchel server must contain HTTP headers containing the digital signature and a public key certificate that maps to the identity of the signer. This identity must be one that has been registered in the server. Alternatively, trusted third parties may be used, such as X500 Certificate Authorities, whose replies can be verified.

There is a need for a secure method of print-by-reference which does not require a prior secure setup and that can be used for both connected clients and mobile clients.

### SUMMARY OF THE INVENTION

In a client-server-document repository system, a secure method, according to the invention, includes sending, from the client to the server, user credentials to release a document, a delegation credential for permitting the server to perform an action on the document and the address of the document; verifying, at the server, the user's credentials and the delegation credential; sending, from the server to the document repository, server credentials, the delegation credential and the address of the document; verifying, at the document repository, the server's credentials and the delegation credential; providing the document to the server; and performing the action on the document.

The client may, for example, be a connected device such as a personal computer or workstation, or a wireless device such as a cell phone or PDA. The server may, for example, be a printer, print server, or a multi-function device which provides printing, scanning, faxing and facilities for storing documents.

The method of the invention enables print-by-reference from a mobile device without a prior secure setup. A user on a PDA or cell phone may deliver a URL of a document to a printer along with the user's credentials to release the document, and a delegation credential giving permission to the printer to obtain and print the document on the user's behalf. The URL and the document may be sent over a wireless link such as IrDA or Bluetooth and TCP/IP using protocols such as HTTP or WAP. A secure protocol such as SSL, Kerberos or WTLS may be used, but is not necessary.

Similarly, for a client that is connected to a network (such as a personal computer or a workstation), where a user on the client delivers a URL of where the document is located to a printer along with the user's credentials to release the document, and a delegation credential giving permission to the printer to obtain and print the document on the user's behalf. The URL and the document may be, for example, sent over TCP/IP using protocols such as FTP, HTTP or email. A secure protocol such as SSL or S/MIME may also be used, but is not necessary. Sending the URL of the document eliminates the need for retrieving a document to a client and sending it securely to a printer especially if the client cannot hold large documents (for example, a hand held PC or PDA) or is not capable of holding electronic documents (for example, a facsimile machine).

### BRIEF DESCRIPTION OF THE FIGURE

FIG. 1 is a block diagram of an architecture for providing a secure method according to the invention.

### DETAILED DESCRIPTION

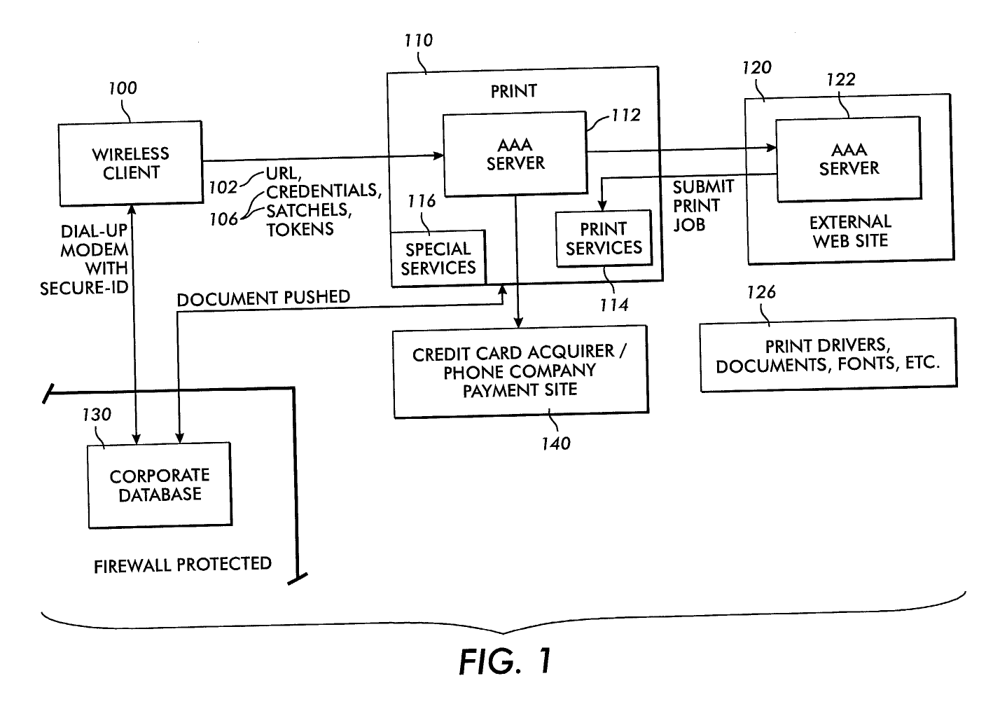

While the method of the invention may be used with any of a number of different type servers, for example, a print server, a printer, a facsimile machine, a multi-function device serving as a remote printer, printer or copier, or an email server to receive a recipient's email, the invention will be described for convenience with a print server or printer. FIG. 1 is a block diagram showing the steps (protocol) involved in providing a secure print by reference with payments.

Client 100 connects to a print server 110, in this case across the Internet. This may be in a secure way (for example, using IrDA, WTLS and WAP involving the exchange of certificates). However, use of a secure connection is optional if the client uses point-and-shoot techniques.

Client 100 provides to the print server 110 the URL 102 of a document to printed or the document to be printed along with the other information such as the number of copies to be printed, type of paper, color, binding, stapling, etc. (this forms the request) and the user's credentials 104. Other information, such as the printer's URL and the sender's IP address, email address for notifications are usually implicitly sent to the print server 110 as part of the Internet Service Provider normal functions.

Client 100 creates a delegation credential 106 (for example, a Satchel token or an SPKI, Simple Public Key Infrastructure, certificate) that is signed by the client (using the private key of the client) and which states the delegator (the client 100), the delegatee (the print server 110), the URL 102 of the document to be fetched, the URL of the print server 110, and the access rights granted (authorization information) and the constraints delegated to the print server 110. The delegation credential (e.g., the Satchel token) is sent to the print server 110.

The client 100 may wish to request multiple documents from the repository. The client 100 may send a separate request for each document (including the user credentials, document information and delegation credential for that particular document). Alternatively, the client 100 may send a single request with user credential and separate delegation credentials for each document. The client 100 may have wish the server to perform different actions on different documents in the document repository. For example, the client 100 may wish to print one document, fax a second document and email a third document. Each document may be located in the same repository or the documents may be located in different repositories.

The print server 110 upon receiving the request, user credentials 104, delegation credential 106, and other information verifies if the user/client 100 has rights to print on the print server. Additionally, the print server 110 may also verify that sufficient paper quota is available and other items specified in the request can be met. If payment information is submitted as part of the user credential 104 or delegation credential 106, the print server 110 verifies if the user is authorized to charge the credit card or other payment account given (including, for example, verification against credit limit). Verification of credit or payment information, if part of the transaction, is accomplished by communicating with the payment provider 140 (which may be a credit card company, bank, telephone company, etc.). Payment information may be contained in either the delegation credential 106 or the user credential 104. Print server 110 sends the credential containing the payment information, the print server's own credentials and the print server's IP address to the payment provider 120. If payment is approved by payment provider 120, the print server 110 communicates with the document repository containing the URL of the document. If payment is denied, the print server 110 sends an authorization error to the client 100. Upon receipt of this information, the client 100 may wish to update its accounting information or credit limit information.

The client 100 could ask the print server 110 to charge the phone company instead of a credit card company. The client's telephone number may be securely transmitted to the print server 110 by encrypting it with the public key provided by the phone company.

The print server 110 sends the delegation credential 106, its own credentials (which may be in the form of a SPKI certificate or Satchel token or ticket), the URL of document requested 102 and its own IP address to the document repository 120. This may optionally be accomplished by establishing a secure channel between the server 112 and the server 122 (which may be AAA server) using, for example, SSL or Kerberos. (Note that servers 112 and 122 need not be capable of establishing a secure connection).

The document repository 120 verifies the information on the delegation credential 106, along with the user's credential 104 and printer's credentials. If valid, the document is sent to the print server 110. Otherwise, an authorization error is sent to the print server 110 that would later be sent to the client 100.

The print server 110 receives the document, prints out the document in accordance with the request using print services 114, updates the quota information (the number of pages printed is subtracted from the quota allotted, or a charge is made to the credit card company), and sends a notification to the client 100 that the document was printed, delivered to an identified location, the user's account was charged an identified amount, and such other administrative information as may be provided by the print server 110.

Print server 110 includes a web server 112 and print service 114. Web server 112 may be AAA server. Alternatively, print server 110 could be a multifunction device that performs such additional functions as retrieving documents from one location (the client 100 or another remote location) and storing them securely on the document repository 120 or another location. In the case of a wireless client 100, this eliminates the need to hot sync the wireless client 100 to a personal computer at a local station. The multi-function device could also perform other actions such as faxing a copy of the retrieved document to a location specified by the user.

Other actions may be available to the user. For example, if the user needs special fonts or printer drivers to print the document in a special format, the user could purchase (lease or borrow as part of a long-term contractual relationship, for example) those special fonts or drivers 126 from an external web site and make a payment to the print server 110 using the payment method described above.

The print server 110 could provide special services 116 to users. Special services 116 may include performing special conversions of documents or sending the document (or parts) out to a different web site for other specialized document services or providing for the downloading of applications, plugins, etc.

Documents need not be located at remote document repositories. The client 100 could connect securely to a corporate database 130 and ask it to push a document to the print server 110. The corporate database may contain a policy to let certain documents be released to a wireless request. Thus, the corporate database would send its credentials and delegated credentials from the client 100 to the print server 110. The print server 110 could examine the credentials from the corporate database 130 and accept the document to be printed.

The above described method may be also be used to accomplish print-by-reference from a client 100 which is connected to a network via a land line. Some variations may be required to accommodate the different protocols used for wireless and land line communications. For example, if the client 100 and print server 110 optionally employ a secure connection, this may be by using TCP/IP, SSL and HTTP involving the exchange of certificates. All communications between the client 100, print server 110, document repository 120, payment authorizers 140 may be over a secure channel, such an SSL channel https, ftps, s-mime, etc., but it is not necessary to do so. The document can be sent either on a secure (e.g., https, ftps, s-mime, etc.) or an insecure (http, ftp, email) channel.

In addition to a wireless client such as a PDA, cell phone or other wireless handheld device, the client 100 may also a web browser on a standard desktop PC, a client application/user interface (UI) of a multi-function device or a facsimile machine.

The document repository 120 may be, for example, a Docushare site, an ordinary web server (Apache), an extended web server (Iplanet, WebSphere, etc.), a document distribution agent (FlowPort, PrintXchange, etc.).

The user credentials may be an X.509 certificate or a Kerberos ticket, or any other suitable secure certificate. The delegation credentials may be a Satchel token or SPKI certificate or any other suitable secure certificate.

The method of the invention enables various security functions to be accomplished.

Authentication: A wireless client and server may establish an authenticated channel. This authenticated channel can be an SSL/WTLS (Wireless Transport Layer Security) channel that uses Bluetooth or IrDA protocol stacks and which runs under HTTP or WAP. In the case of a non-wireless client and server, this may be accomplished when the client and server exchange their credential information (such as X.509 certificates). This authenticated channel may also be an SSL channel that runs over TCP/IP and that runs under HTTP. The combined protocol is usually termed an HTTPS channel. The printer and the document repository may authenticate each other using X.509 certificates or Kerberos tickets. A mail message sent from the printer to the document repository using S/MIME could be used to provide authentication of origin.

Authorization. The user credential may include extensions that provide information on what actions the holder of the credential can perform. This information may include whether the user can print, fax, copy, fetch (get) a document, store a document, etc. In addition, the credential may contain constraints (print 500 copies per week, print between 5:00 AM and 9:00 PM, store in /usr/local/temp only, read from public directory, etc.). A subset of this information may also be included as part of the delegated credential as described in the next step. Alternatively, if Kerberos tickets are used, each Kerberos ticket may be equipped with authorization features that contain rights and restrictions. An EACL (Extended Access Control List) could be used on the server (print server or document repository) to perform authorization. A subset of this information may also be included as part of the delegation credential.

Delegation. The delegation credential (such as a Satchel Token) is created by the delegator (the user or client) to give permissions to a delegatee (the printer or print server or multi-function device or other device) that will enable the delegatee to act on behalf of the delegator. In addition to specifying what the delegatee can perform, the delegation credential may specify the certain restrictions or constraints, such as duration of the permissions. For example, in the case of a print document request, the life of the delegation credential may be defined to be as small as 10-15 minutes (which should be sufficient time to perform the various verifications and to print a document). The delegation credential may contain a subset of the client's authorization information along with constraints. In case of Kerberos, a delegation ticket could be used. Another example of such a delegation credential is an attribute certificate.

Non-repudiation/Audit. The transaction information along with credentials may stored in an audit record both at the print server and the document repository site to later prevent the client from denying that it sent out a print request.

Electronic payment. The extensions of the user credential or the delegation credential may contain an encrypted credit card number or telephone number for payment purposes. The number may be encrypted using the public key of the credit card company or telephone company.

It will be appreciated that the present invention may be readily implemented in software using software development environments that provide portable source code that can be used on a variety of hardware platforms. Alternatively, the disclosed system may be implemented partially or fully in hardware using standard logic circuits. Whether software or hardware is used to implement the system varies depending on the speed and efficiency requirements of the system and also the particular function and the particular software or hardware systems and the particular microprocessor or microcomputer systems being utilized.

The invention has been described with reference to a particular embodiment. Modifications and alterations will occur to others upon reading and understanding this specification taken together with the drawings. The embodiments are but examples, and various alternatives, modifications, variations or improvements may be made by those skilled in the art from this teaching which are intended to be encompassed by the following claims.

What is claimed is:

1. In a client-server-document repository system, a secure method, comprising:
sending, from the client to the server, user credentials to release a document, a delegation credential for permitting the server to perform an action on the document and the address of the document;
verifying, at the server, the user's credentials and the delegation credential;
sending, from the server to the document repository, server credentials, the delegation credential and the address of the document;
verifying, at the document repository, the server's credentials and the delegation credential;
providing the document to the server; and
performing the action on the document.

2. The method of claim 1, wherein the server comprises a printer.

3. The method of claim 1, wherein the server comprises a multi-function device for printing, faxing and scanning.

4. The method of claim 1, further comprising establishing a secure connection between the client and server prior to sending the user credentials, delegation credential and location of the document.

5. The method of claim 1, wherein the document location comprises a URL.

6. The method of claim 1, wherein the delegation credential comprises a certificate signed by the client and including the delegator, delegatee, URL of the document to be fetched, URL of the server, access rights and constraints delegated to the server.

7. The method of claim 1, wherein the client comprises a mobile device.

8. The method of claim 7, wherein the mobile device comprises a PDA.

9. The method of claim 7, wherein the mobile device comprises a cell phone.

10. The method of claim 1, wherein the delegation credential includes a time limit, wherein upon expiration of the time limit, the server's permissions expire.

11. The method of claim 1, further comprising:
sending, from the client to the server, a delegation credential for authorizing payment for the action to be performed by the server;
sending, from the server to a payment provider, server credentials and the payment delegation credential;
verifying, at the payment provider, the server's credentials and the payment delegation credential, and if valid directing payment to the server.

12. The method of claim 1, wherein the delegation credential comprises a Satchel token.

13. The method of claim 1, wherein the delegation credential comprises an SPKI certificate.

14. The method of claim 1, wherein the server comprises a printer and the action comprises printing the document and wherein the verifying step comprises verifying if the client has rights on the printer and if not sending an error message to the client.

15. The method of claim 14, further comprising verifying, at the printer, if sufficient media is available.

16. The method of claim 15, further comprising, upon printing the document, sending the client a notice.

17. The method of claim 3, wherein the delegation credential includes the client's access rights associated with the document and constraints on the server.

18. The method of claim 17, wherein the client's access rights include printing, faxing, copying and fetching and wherein the server's constraints include a predetermined number of copies that may be made and a predetermined period of time in which actions on the document may be provided.

19. In a client-server-document repository system, a secure method, comprising:
sending, from the client to the server, user credentials to release a plurality of documents and a plurality of delegation credentials, wherein each delegation credential includes permissions for the server to perform an action on a document and the address of the document;
for each delegation credential,
verifying, at the server, the user's credentials and the delegation credential;
sending, from the server to the document repository, server credentials, the delegation credential and the address of the document;
verifying, at the document repository, the server's credentials and the delegation credential;
providing the document to the server; and
performing the action on the document.
